(19) United States
(12) Patent Application Publication
(10) Pub. No.: US 2005/0213939 A1
(43) Pub. Date: Sep. 29, 2005

(54) Decoding and recording apparatus

(75) Inventor: Takuya Suzuki, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Osaka (JP)

(21) Appl. No.: 11/050,894

(22) Filed: Feb. 4, 2005

(30) Foreign Application Priority Data
Feb. 10, 2004 (JP) JP2004-032925

(51) Int. Cl. H04N 5/76; G11B 15/04; G11B 19/04

(52) U.S. Cl. 386/94; 360/60; 380/201

(57) ABSTRACT

In recording video/audio information in a digital broadcasting, only when copy control information contained in the video/audio information includes a copy-once signal, a recording processing unit records the video/audio information on an optical disk by an optical disk drive. In editing the video/audio information recorded on the optical disk regardless of the copy control information, when the video/audio information read out from the optical disk has not been subjected to a processing by a CPRM signal and a period free from the processing is not longer than a predetermined time, an edition processing unit deletes a CM segment with the determination that the video/audio information corresponds to the CM segment.

### BACKGROUND OF THE INVENTION

1. Field of the Invention

This invention relates to a decoding and recording apparatus which by determining the contents of copy control information contained in video/audio information decoded from a received broadcast signal, can determine whether or not the video/audio information is recordable, and if recordable, records the video/audio information on a recording medium.

2. Description of the Related Art

In recent years, digital broadcasting in satellite broadcasting and digital broadcasting in ground-wave broadcasting which has become recently prevalent are known. In order to receive these digital broadcasts, a device called “set-top-box” (STB) including a tuner for tuning the broadcasting radio wave received through an antenna, and a decoder for decoding the broadcast signal tuned by this tuner must be prepared. Further, this STB must be connected to a television receiver.

Meanwhile, the video/audio information broadcasted in the digital broadcasting is supplemented with copy control information. This copy control information is the information for limiting the copying of the video/audio information thus broadcasted, which indicates how the video/audio information broadcasted can be recorded by a user. The copy control information generally consists of two bits defined as “00” indicative of “copy free” (copying is permitted unconditionally); “10” indicative of “copying is permitted only once”; “01” indicative of “no-more-copies”; and “11” indicative of copy protection. Incidentally, “copy-once” signal in this specification refers to a signal indicative of that copying can be done only once.

As a recording medium for recording the video/audio information, a hard disk, an optical drive, a magnetic tape are known. The recording devices such as a hard-disk drive, optical-disk drive and VTR for driving these recording media are incorporated in or externally attached to the STB.

When the user intends to record the video/audio information, the user selects the recording device. As a result of extraction/analysis of the copy control information by the STB, if it is determined that copying is not problematic, the recording device is operated to record the video/audio information on the recording medium. On the other hand, if it is determined that the copying is protected, the video/audio information is not recorded but a message such as “this information cannot be copied” will be displayed.

### SUMMARY OF THE INVENTION

As described above, when the user records the video/audio information, the user selects the recording device. The STB or the recording device selected then performs the recording operation according to the copy control information. Specifically, if the copy control information is “00”, no problem occurs because the copying is permitted unconditionally. Further, if the copy control information is “01” or “11”, in this case also, no problem particularly occurs because the copying is protected.

However, if the copy control information is “10” (the copy control information includes the copy-once signal), the following problem occurs. In this case, since there is a condition that the copying is permitted only once, if the copying is done only by the hard disk driver selected as the recording device, the video/audio information recorded in the hard disk cannot be copied for saving and editing on the other recording devices.

In order to obviate such an inconvenience, in a related art disclosed in Japanese Patent No. 3438694, the video/audio information (contents) with the condition that copying is permitted only once is recoded in the optical disk through the recording operation by the optical disk drive while also enabling the editing simultaneously. Namely, if the video/audio information to be recorded includes a CM segment (unnecessary segment), in order to delete this CM (commercial) segment, the contents of the transport stream supplied from the tuner unit are judged. On the basis of this judgment, the CM segment included in the video/audio information is deleted to edit/record the video/audio information.

However, the related art disclosed in Japanese Patent No. 3438694 does not disclose how the judgment on whether the contents of the transport stream is the program part or the CM part is conducted. In conducting such a judgment, it is difficult to discriminate between the program part and the CM part of the transport stream based on the signals. This presents a problem of making the processing required for the judgment very complicate.

Incidentally, related arts disclosed in JP-A-2003-22610 and JP-A-2003-199007, which are silent on the processing of deleting the CM segment to edit the video/audio information, cannot solve the above problem.

This invention has been accomplished in order to solve the above problem. An object of this invention is to provide a decoding and recording apparatus which can perform, through simple processing, the processing of recording video/audio information in digital broadcasting according to copy control information and also editing the video/audio information with a CM part deleted.

In order to attain the above object, according to a first aspect of the invention, there is provided a decoding and recording apparatus which by determining contents of copy control information contained in video/audio information decoded from a received digital broadcast signal, determines whether or not the video/audio information is recordable, and if recordable, records the video/audio information on a first recording medium, including: a recording processing unit for receiving the digital broadcast signal and recoding the video/audio information decoded from the received broadcast signal; and an edition processing unit for editing video/audio information recorded on a second recording medium; wherein the recording processing unit includes: a copy-once determining means for determining whether or not the copy control information contained in the video/audio information has the copy-once signal; and a first recording control means for performing a control for recording the video/audio information on the first recoding medium while encrypting the video/audio information through a processing by a CPRM signal if it is determined that the copy control information has the copy-once signal, and not recording the video/audio information on the first recording medium if it is determined that the copy control information does not have the copy-once signal; and the edition processing unit includes: a CPRM determining means for determining whether or not the video/audio information read out from the second recording medium has been subjected to the processing by the CPRM signal; a second recording control means for making a control of recording the video/audio information on a third recording medium if it is determined that the video/audio information has been subjected to the processing by the CPRM signal; a CPRM-free period determining means for determining whether or not a period free from the processing by the CPRM signal for the video/audio information is longer than a predetermined time if it is determined that the video/audio information has not been subjected to the processing by the CPRM signal; a third recording control means for recording the video/audio information on the third recording medium if it is determined that the period free from the processing by the CPRM signal is longer than the predetermined time; and a CM deleting means for deleting the CM segment with determination that the pertinent video/audio information corresponds to the CM segment if it is determined that the period free from the processing by the CPRM signal is not longer than the predetermined time.

In accordance with this configuration, in recording the video/audio information decoded from a received broadcast signal, in the recording control unit, if the copy-once determining means determines that the copy control signal included in the video/audio information has the copy-once signal, the first recording control means makes the control of recording on the recording medium the video/audio information encrypted by the processing by a CPRM signal. If the copy-once determining means determines that the copy control signal does not have the copy-once signal, the first recording control means makes the control of not recording the video/audio information on the recording medium.

In editing the video/audio information recorded on the recording medium regardless of the presence/absence of the copy control signal, in the edition processing unit, if the CPRM determining means determines that the video/audio information read out from the recording medium has been subjected to the processing by a CPRM signal or CPRM processing, the second recording control means makes the control of recording the video/audio information on the recording medium. If the CPRM determining means determines that the video/audio information has not been subjected to the processing by the CPRM signal and a CPRM-free period determining means determines that the period free from the CPRM processing for the video/audio information is longer than a predetermined time, the third recording control means makes the control of recording the video/audio information on the recording medium. Further, if the CPRM determining means determines that the video/audio information has not been subjected to the processing by the CPRM signal and the CPRM-free period determining means determines that the period free from the CPRM processing is not longer than a predetermined time, the CM canceling means cancels the CM segment with determination that the pertinent video/audio information corresponds to the CM segment.

In accordance with this configuration, in recording the video/audio information in the digital broadcasting, the video/audio information can be recorded on the optical disk according to the copy control information, the video/audio information with the CM segment omitted can be recorded. Further, in editing the video/audio information recorded on the optical disk regardless of the presence/absence of the copy control signal, if the video/audio information has not been subjected to the processing by the CPRM signal and the period free from the CPRM processing is not longer than a predetermined time, the CM segment is cancelled with the determination that the video/audio information corresponds to the CM segment. Thus, the video/audio information can be edited through simple processing.

According to a second aspect of the invention, there is provided a decoding and recording apparatus which by determining contents of copy control information contained in video/audio information decoded from a received digital broadcast signal, determines whether or not the video/audio information is recordable, and if recordable, records the video/audio information on a first recording medium, including: a recording processing unit for receiving the digital broadcast signal and recoding the video/audio information decoded from the received broadcast signal; and an edition processing unit for editing video/audio information recorded on a second recording medium; wherein only when the copy control information contained in the video/audio information has a copy-once signal, the recording processing unit records the video/audio information on the first recording medium; and when the video/audio information read out from the second recording medium which is recorded regardless of the copy control information has not been subjected to copy control processing and a period free from the copy control processing is not longer than a predetermined time, the edition processing unit determines that the video/audio information corresponds to a CM segment and deletes the CM segment.

In this configuration, in recording video/audio information in a digital broadcasting, only if the copy control signal included in the video/audio information has a copy-once signal, the recording control unit records the video/audio information on the recording medium.

Further, in editing the video/audio information recorded on the optical disk regardless of the presence/absence of the copy control signal, if the video/audio information read out from the recording medium regardless of the copy control signal has not been subjected to the copy control processing and the period free from the copy control processing is not longer than a predetermined time, the CM segment is cancelled with the determination that the video/audio information corresponds to the CM segment.

In accordance with this configuration, in recording the video/audio information in the digital broadcasting, since the video/audio information can be recorded on the optical disk according to the copy control information, the video/audio information with the CM segment omitted can be recorded. Further, in editing the video/audio information recorded on the optical disk regardless of the presence/absence of the copy control signal, if the video/audio information has not been subjected to the copy control processing and the period free from the copy control processing is not longer than a predetermined time, the CM segment is cancelled with the determination that the video/audio information corresponds to the CM segment. Thus, the video/audio information can be edited through simple processing.

According to a third aspect of the invention, the recording processing unit includes: a copy-once determining means for determining whether or not the copy control information contained in the video/audio information has the copy-once signal; and a first recording control means for performing a control for recording the video/audio information on the first recoding medium if it is determined that the copy control information has the copy-once signal, and not recording the video/audio information on the first recording medium if it is determined that the copy control information does not have the copy-once signal. In this configuration, in recording the video/audio information in the digital broadcasting, the video/audio information with the CM segment omitted can be recorded.

According to a fourth aspect of the invention, the edition processing unit includes: a CPRM determining means for determining whether or not the video/audio information read out from the second recording medium has been subjected to a processing by a CPRM signal serving as the copy control processing; a second recording control means for making a control of recording the video/audio information on a third recording medium if it is determined that the video/audio information has been subjected to the processing by the CPRM signal; a CPRM-free period determining means for determining whether or not the period free from the processing by the CPRM signal for the video/audio information is longer than the predetermined time if it is determined that the video/audio information has not been subjected to the processing by the CPRM signal; a third recording control means for recording the video/audio information on the third recording medium if it is determined that the period free from the processing by the CPRM signal is longer than the predetermined time; and a CM deleting means for deleting the CM segment with determination that the pertinent video/audio information corresponds to the CM segment if it is determined that the period free from the processing by the CPRM siganal is not longer than the predetermined time. In this configuration, in editing the video/audio information recorded on the optical disk regardless of the presence/absence of the copy control signal, if the video/audio information has not been subjected to the processing by the CPRM signal and the period free from the CPRM processing is not longer than a predetermined time, the CM segment can be cancelled with the determination that the video/audio information corresponds to the CM segment.

In accordance with this invention, the decoding and recording apparatus comprises a recording control unit for recoding the video/audio information decoded from the received broadcast signal, and an edition processing unit for editing the video/audio information recorded on the recording medium regardless of the presence or absence of the copy control signal. The recording processing unit includes a copy-once determining means for determining whether or not the copy control signal included in the video/audio information has a copy-once signal and a first recording control means for making the control for recording on the recording medium the video/audio information encrypted by the processing by a CPRM signal or CPRM processing if it is determined that the copy control signal has the copy-once signal, and not recording the video/audio information on the recording medium if it is determined that the copy control signal does not have the copy-once signal. The edition processing unit includes a CPRM determining means for determining whether or not the video/audio information read out from the recording medium has been subjected to the processing by a CPRM signal, a second recording control means for making the control of recording the video/audio information on the recording medium if it is determined that the video/audio information has been subjected to the processing by the CPRM signal, a CPRM-free period determining means for determining whether or not the period free from the CPRM processing for the video/audio information is longer than a predetermined time if it is determined that the video/audio information has not been subjected to the processing by the CPRM signal, a third recording control means for recording the video/audio information on the recording medium if it is determined that the period free from the CPRM processing is longer than the predetermined time, and a CM canceling means for canceling the CM segment with determination that the video/audio information corresponds to the CM segment if it is determined that the period free from the CPRM processing is not longer than the predetermined time. In this configuration, in recording the video/audio information in the digital broadcasting, the video/audio information can be recorded on the optical disk according to the copy control information, the video/audio information with the CM segment omitted can be recorded. Further, in editing the video/audio information recorded on the optical disk regardless of the presence/absence of the copy control signal, if the video/audio information has not been subjected to the processing by the CPRM signal and the period during which the video/audio information is not subjected to the processing by the CPRM signal is not longer than a predetermined time, the CM segment is cancelled with the determination that the video/audio information corresponds to the CM segment. Thus, the video/audio information can be edited through simple processing.

Also, in accordance with this invention, the decoding and recording apparatus comprises a recording control unit for recoding the video/audio information decoded from the received broadcast signal, and an edition processing unit for editing the video/audio information recorded on the recording medium. Only if the copy control signal included in the video/audio information has a copy-once signal, the recording control unit records the video/audio information on an optical disk; and if the video/audio information read out from the optical disk regardless of the presence/absence of the copy control signal has not been subjected to copy control processing and the period free from the copy control processing is not longer than a predetermined time, the edition processing unit cancels a CM segment with the determination that the video/audio information corresponds to the CM segment. In this configuration, in recording the video/audio information in the digital broadcasting, since the video/audio information can be recorded on the optical disk according to the copy control information, the video/audio information with the CM segment omitted can be recorded. Further, in editing the video/audio information recorded on the optical disk regardless of the presence/absence of the copy control signal, if the video/audio information has not been subjected to the copy control processing and the period free from the copy control processing is not longer than a predetermined time, the CM segment can be cancelled with the determination that the video/audio information corresponds to the CM segment. Thus, the video/audio information can be edited through simple processing.

### BRIEF DESCRIPTION OF THE DRAWINGS

FIG. 1 is a block diagram showing a configuration of a decoding and recording apparatus according to a first embodiment of this invention;

FIG. 2 is flowchart for explaining a processing when video/audio information decoded from a broadcast signal is recorded in this embodiment; and

FIG. 3 is a flowchart for explaining a processing when the video/audio information recorded on a recording medium is edited regardless of presence/absence of a copy control signal.

### DETAILED DESCRIPTION OF THE PREFFERED EMBODIMENTS

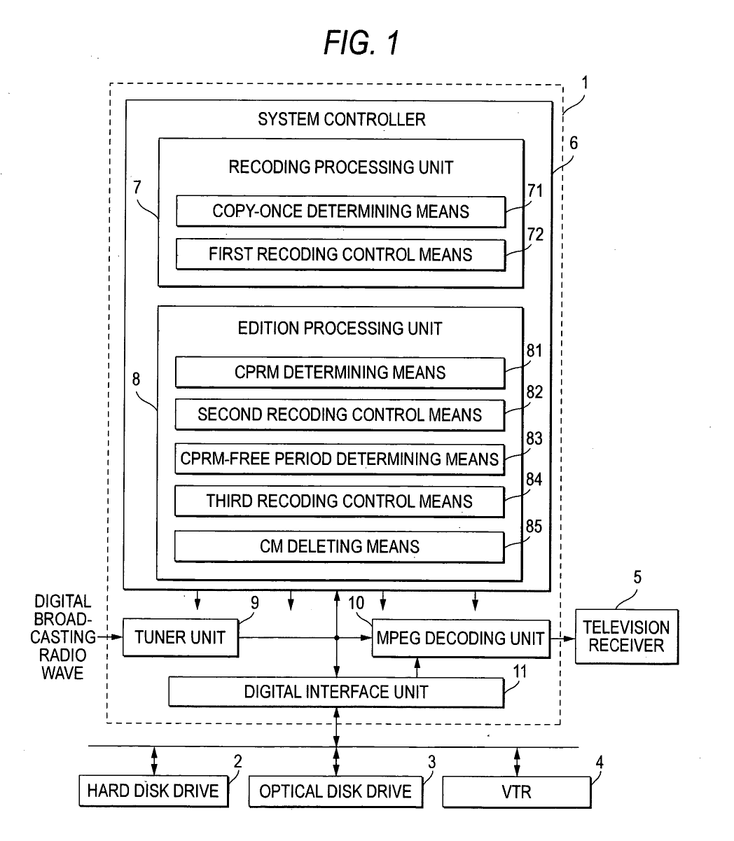

Now referring to the drawings, an explanation will be given of an embodiment of this invention. FIG. 1 is a block diagram showing a configuration of a decoding and recording apparatus according to a first embodiment of this invention.

The decoding and recording apparatus includes a STB 1 and various recoding devices such as a hard disk drive 2 for recording information on a hard disk serving as a recording medium, an optical disk drive 3 for recording the information on an optical disk such as DVD (digital versatile disk) serving as the recording medium and a VTR (video tape recorder) for recording the information on a magnetic tape serving as the recording medium.

The STB 1 includes a system controller 6 for controlling itself and the whole of the recording devices, a tuner unit 9 for tuning a received digital broadcasting wave, an MPEG decoding unit 10 for decoding the MPEG compressed data from the tuner 9, and a digital interface unit 11 for data input/output for the recording devices and other external devices.

The system controller 6 includes a recording processing unit 7 for recoding the video/audio information decoded from the broadcast signal, and an edition processing unit 8 for editing the video/audio information recorded on the recording medium of the recording device regardless of a copy control signal.

The recording processing unit 7 includes a copy-once determining means 71 for determining whether or not the copy control signal included in the video/audio information has the copy-once signal and a first recording control means 72 for performing the control for recording on the recording medium the video/audio information encrypted by the processing by a CPRM signal or CPRM processing if it is determined that the copy control signal has the copy-once signal, and not recording the video/audio information on the recording medium if it is determined that the copy control signal does not have the copy-once signal.

The edition processing unit 8 includes a CPRM (Content Protection for Recordable Media) determining means 81 for determining whether the video/audio information read out from the recording medium has been subjected to the processing by a CPRM signal; a second recording control means 82 for making the control of recording the video/audio information on the recording medium if it is determined that the video/audio information has been subjected to the processing by the CPRM signal; a CPRM-free period determining means 83 for determining whether or not the period free from the CPRM processing for the video/audio information is longer than a predetermined time if it is determined that the video/audio information has not been subjected to the processing by the CPRM signal; a third recording control means 84 for recording the video/audio information on the recording medium if it is determined that the period free from the CPRM processing is longer than the predetermined time; and a CM deleting means 85 for deleting the CM segment with determination that the pertinent video/audio information corresponds to the CM segment if it is determined that the period free from the CPRM processing is not longer than the predetermined time.

The CPRM has been developed for the recordable media and realizes sophisticated copyright protection (copy control) using a key block called MKB (Media Key Block) recorded on the side of the media and a device key prepared on the side of optical disk reproducing device. The CPRM is a powerful copy control technique which further enhances CSS (Content Scramble System) adopted in the DVD video and supports a function of nullifying a cipher key when it has been leaked.

All the contents (video/audio information) recorded or to be recorded on the media (optical disk) are encrypted. During the reproduction, the optical disk reproducing device creates the media key necessary for deciphering the encryption using the device key provided on the side of the optical disk reproducing device and the MKB recorded on the media (optical disk), and deciphers the encryption of the contents to be reproduced.

In the CPRM, in a lead-in area, MKB is recorded. In an area called BCA (Burst Cutting Area), an inherent ID information (media ID) different for each of the media is recorded. Both cannot be copied and altered. The maximum number of the MKB is predetermined. For each predetermined number of media, the MKB is updated.

The encryption of the contents creates an encryption title key on the basis of the device key and media key created by the MKB and the media ID. The contents are actually created using the key created from the data composed of the encryption title key and the CCI (Copy Control Information). During the recording, the CCI is sent from the side of the contents, and encrypted and recorded together with the contents. The CCI not encrypted is also distributed. If both do not agree with each other, it is regarded that this is injustice.

The tuner unit 9 receives and demodulates the digital broadcasting radio wave, and carries out error correction processing using Viterbi demodulation and Reed-Solomon code, and produces the resultant radio wave as a transport stream of e.g. MPEG-2 standard. The MPEG decoding unit 10 receives the transport stream supplied from the tuner unit 9 and decodes the MPEG-compressed video/audio data to be sent to the television receiver 5.

The digital interface unit 11 receives the transport stream sent from the tuner unit 9, and supplies it to the recording device and other external devices and supplies the transport stream from the recording device and other external devices to the MPEG decoding unit 10. As the digital interface unit 11, e.g. an interface called IEEE1394 is employed.

The hard disk drive 2, which is one of the recording devices, is considered to be incorporated in the STB 1 in many cases, but may be an outboard type externally connected to the STB 1 through the digital interface unit 11. This embodiment may employ either the inboard type or outboard type thereof. The optical disk drive 3 and VTR 4 are generally the outboard type through the digital interface unit 11, but may be the inboard type that are incorporated in the STB 1. This embodiment may employ either the inboard type or outboard type thereof. In the embodiment shown in FIG. 1, these recording devices are externally connected to the STB 1.

Meanwhile, the hard disk housed in the hard disk drive has an advantage that it has a large recording capacitor to permit endless recording from the start when overflow occurs by continuous recording. Therefore, the hard disk is suitable to time shift watching that the broadcasting programs are recorded regardless of their contents, and afterwards, only a desired program(s) is played back. However, the hard disk serving as the recording medium cannot be taken out from the hard disk drive so as to be replaced by a new one. Thus, if overflow of the recording on the hard disk occurs, a part of the recorded data must be deleted and new recording must be done. This is a shortcoming of the hard disk.

The optical disk 3 driven by the optical disk drive 3 can be replaced by a new one. The optical disk 3 has an advantage that it can designate the order of reproducing the recorded data and realize the editing accompanied by recording on the optical disk. Therefore, although the recording capacity for each sheet of the optical disk is smaller than that of the hard disk, the recording capacity thereof can be considered limitless by replacement of the optical disk.

The magnetic tape driven by the VTR 4 has an advantage that it has a large recording capacity and can be replaced by a new one. Therefore, the magnetic tape is suitable to recording or saving broadcasting programs without selecting their contents. However, the magnetic tape has a shortcoming that it takes a lot of time for searching and editing on the magnetic tape.

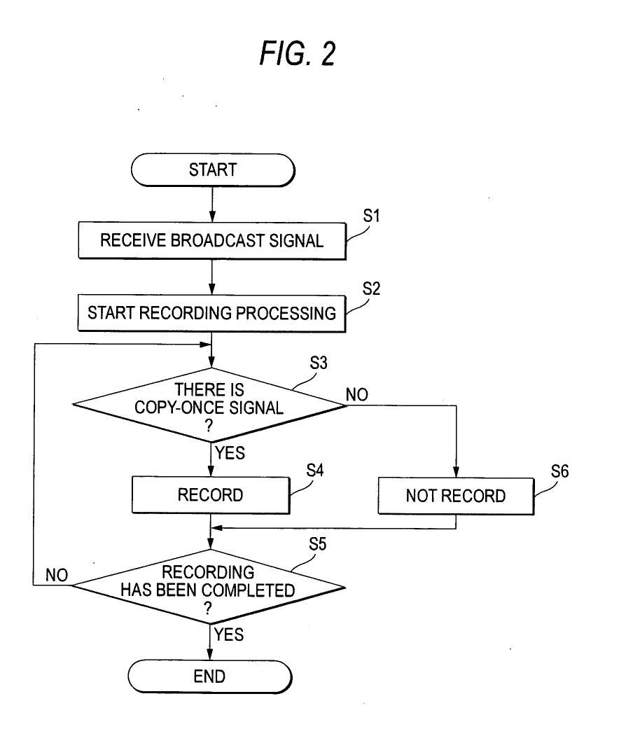

FIG. 2 is flowchart for explaining the processing when the video/audio information decoded from a broadcast signal is recorded in this embodiment. Referring to this flowchart, an explanation will be given of the processing when the video/audio information is recorded.

The digital broadcast signal is received (step S1), and the processing of recording the video/audio information decoded from the broadcast signal is started (step S2). In the recording processing unit 7 of the system controller 6 within the STB 1, if the copy-once determining means 71 determines that the copy control signal included in the video/audio information includes a copy-once signal (step S3), the first recording control means 72 makes the control of encrypting the video/audio information through the processing by a CPRM signal and recording the information thus encrypted on the recording medium (step S4). Namely, the first recording control means 72 causes the optical disk drive 3 to perform the recording operation so that the video/audio information encrypted through the processing by the CPRM signal is recorded on the optical disk.

If the copy-once determining means 71 determines that the copy control signal does not include the copy-once signal (step S3), the first recording control means 72 makes the control of not recording the video/audio information on the optical disk. Namely, the first recording control means 72 stops the recording operation of the disk drive 3 so that the video/audio information is not recorded on the optical disk.

After the processing step S4 or step S6, the same processing is repeated until the recording of the video/audio information is completed (step S5). Through the processing described above, since the video/audio information in the digital broadcasting can be recorded on the optical disk according to the copy-once signal of the copy control information, the video/audio information with the CM segment omitted can be recorded.

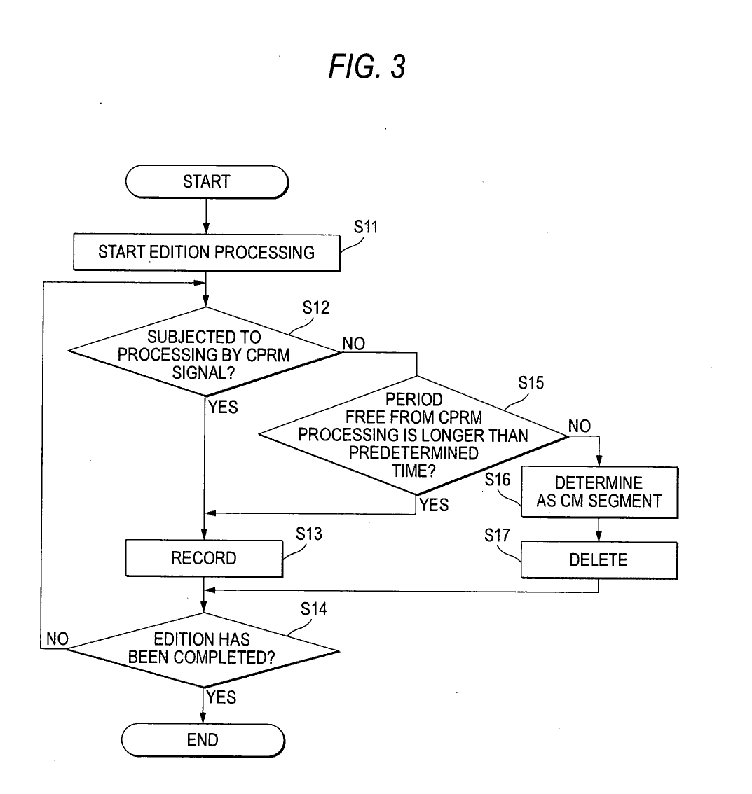

FIG. 3 is a flowchart for explaining the processing when the video/audio information recorded on the recording medium is edited regardless of the copy control signal. Referring to this flowchart, an explanation will be given of the processing when the video/audio information recorded on the recording medium is edited regardless of the copy control signal.

When the processing of editing the video/audio information recorded on e.g. an optical disk regardless of the copy control signal is started (step S11), in the CPRM determining unit 8, if the CPRM determining means 81 determines that the video/audio information read out from the optical disk through the optical disk drive 3 has been subjected to the processing by a CPRM signal or CPRM processing (step S12), the second recording control means 82 makes the control of recoding the video/audio information on the optical disk (step S13). Namely, the second recording control means 82 causes the optical disk drive 3 to perform the recording operation so that the video/audio information encrypted through the processing by the CPRM signal is recorded on the optical disk.

If the CPRM determining means 81 determines that the video/audio information has not been subjected to the processing by the CPRM signal (step S12) and if the CPRM-free period determining means 83 determines that the period free from the CPRM processing is longer than a predetermined time (step S15), the third recording control means 84 controls the optical disk drive 3 to record the video/audio information on the optical disk (step S13).

If the CPRM determining means 81 determines that the video/audio information has not been subjected to the processing by the CPRM signal (step S12) and if the CPRM-free period determining means 83 determines that the period free from the CPRM processing is not longer than a predetermined time (step S15), the CM deleting means 85 determines that the pertinent video/audio information corresponds to the CM segment (step S16), and deletes the CM segment (step S17). Instead of deleting the CM segment, the CM segment may be separated from the pertinent video/audio information. The separation of the CM segment from the video/audio information to be edited means that the CM segment has been deleted from the video/audio information to be edited. Therefore, the “deleting” referred to here in includes the concept of “separation”.

Through the processing described above, where the video/audio information recorded on the optical disk is edited regardless of the copy control signal, if the video/audio information has not been subjected to the processing by the CPRM signal and the period free from the CPRM processing is not longer than a predetermined time, the CM segment is cancelled with the determination that the video/audio information corresponds to the CM segment. Thus, the video/audio information can be edited through simple processing.

1. A decoding and recording apparatus which by determining contents of copy control information contained in video/audio information decoded from a received digital broadcast signal, determines whether or not the video/audio information is recordable, and if recordable, records the video/audio information on a first recording medium, comprising:
a recording processing unit for receiving the digital broadcast signal and recoding the video/audio information decoded from the received broadcast signal; and
an edition processing unit for editing video/audio information recorded on a second recording medium;
wherein the recording processing unit comprises:
a copy-once determining means for determining whether or not the copy control information contained in the video/audio information has the copy-once signal; and
a first recording control means for performing a control for recording the video/audio information on the first recoding medium while encrypting the video/audio information through a processing by a CPRM signal if it is determined that the copy control information has the copy-once signal, and not recording the video/audio information on the first recording medium if it is determined that the copy control information does not have the copy-once signal; and
the edition processing unit comprises:
a CPRM determining means for determining whether or not the video/audio information read out from the second recording medium has been subjected to the processing by the CPRM signal;
a second recording control means for making a control of recording the video/audio information on a third recording medium if it is determined that the video/audio information has been subjected to the processing by the CPRM signal;
a CPRM-free period determining means for determining whether or not a period free from the processing by the CPRM signal for the video/audio information is longer than a predetermined time if it is determined that the video/audio information has not been subjected to the processing by the CPRM signal;
a third recording control means for recording the video/audio information on the third recording medium if it is determined that the period free from the processing by the CPRM signal is longer than the predetermined time; and
a CM deleting means for deleting the CM segment with determination that the pertinent video/audio information corresponds to the CM segment if it is determined that the period free from the processing by the CPRM signal is not longer than the predetermined time.

2. A decoding and recording apparatus which by determining contents of copy control information contained in video/audio information decoded from a received digital broadcast signal, determines whether or not the video/audio information is recordable, and if recordable, records the video/audio information on a first recording medium, comprising:
a recording processing unit for receiving the digital broadcast signal and recoding the video/audio information decoded from the received broadcast signal; and
an edition processing unit for editing video/audio information recorded on a second recording medium;
wherein only when the copy control information contained in the video/audio information has a copy-once signal, the recording processing unit records the video/audio information on the first recording medium; and
when the video/audio information read out from the second recording medium which is recorded regardless of the copy control information has not been subjected to copy control processing and a period free from the copy control processing is not longer than a predetermined time, the edition processing unit determines that the video/audio information corresponds to a CM segment and deletes the CM segment.

3. The decoding and recording apparatus according to claim 2, wherein the recording processing unit comprises:
a copy-once determining means for determining whether or not the copy control information contained in the video/audio information has the copy-once signal; and
a first recording control means for performing a control for recording the video/audio information on the first recoding medium if it is determined that the copy control information has the copy-once signal, and not recording the video/audio information on the first recording medium if it is determined that the copy control information does not have the copy-once signal.

4. The decoding and recording apparatus according to claim 2, wherein the edition processing unit comprises:
a CPRM determining means for determining whether or not the video/audio information read out from the second recording medium has been subjected to a processing by a CPRM signal serving as the copy control processing;
a second recording control means for making a control of recording the video/audio information on a third recording medium if it is determined that the video/audio information has been subjected to the processing by the CPRM signal;
a CPRM-free period determining means for determining whether or not the period free from the processing by the CPRM signal for the video/audio information is longer than the predetermined time if it is determined that the video/audio information has not been subjected to the processing by the CPRM signal;
a third recording control means for recording the video/audio information on the third recording medium if it is determined that the period free from the processing by the CPRM signal is longer than the predetermined time; and
a CM deleting means for deleting the CM segment with determination that the pertinent video/audio information corresponds to the CM segment if it is determined that the period free from the processing by the CPRM siganal is not longer than the predetermined time.
